(19) United States
(12) Patent Application Publication
(10) Pub. No.: US 2019/0057345 A1
(43) Pub. Date: Feb. 21, 2019

(54) SYSTEMS AND METHODS FOR DELIVERY OF COMMERCIAL ITEMS

(71) Applicant: Walmart Apollo, LLC, Bentonville, AR (US)

(72) Inventors: David C. Winkle, Bella Vista, AR (US); John J. O'Brien, Farmington, AR (US)

(21) Appl. No.: 16/104,420

(22) Filed: Aug. 17, 2018

Related U.S. Application Data
(60) Provisional application No. 62/546,787, filed on Aug. 17, 2017.

(51) Int. Cl. G06Q 10/08; G05D 1/02; G06Q 10/06

(52) U.S. Cl. CPC G06Q 10/0832; G06Q 10/06316; G05D 1/0287

(57) ABSTRACT

In some embodiments, apparatuses and methods are provided herein useful to delivering commercial items. In some embodiments, there is provided a system for a self-electing unmanned vehicle for delivery of commercial items including a UV of a plurality of UVs comprising: a UV control circuit configured to: receive a data request for a task elector; determine resource values associated with a plurality of UV resources to be cooperatively utilized to fulfill one or more tasks; compare each resource value to a corresponding specification value; assign a particular confidence level to each of one or more task identifiers based on the comparison; and provide a self-election response indicating an election of corresponding task to a central control circuit based on the comparison and the assignment when each of the resource values is at least within a threshold value of the corresponding specification value; a plurality of sensors; and a transport system.

### CROSS-REFERENCE TO RELATED APPLICATION

This application claims the benefit of U.S. Provisional Application No. 62/546,787, filed Aug. 17, 2017, which is incorporated herein by reference in its entirety.

### TECHNICAL FIELD

This invention relates generally to delivering commercial items.

### BACKGROUND

Generally, when a customer submits a retail order for a retail item, the customer indicates on the retail order where and/or to whom to deliver the retail item. Depending on instructions indicated on the retail order, a delivery agent may deliver the retail item at a home or place of work of the customer.

### BRIEF DESCRIPTION OF THE DRAWINGS

Disclosed herein are embodiments of systems, apparatuses and methods pertaining to a self-electing unmanned vehicle (UV) for delivering commercial items. This description includes drawings, wherein:

FIG. 1 illustrates a simplified block diagram of an exemplary system for delivering commercial items in accordance with some embodiments;

FIG. 2 shows a flow diagram of an exemplary process for delivering commercial items in accordance with some embodiments;

FIG. 3 shows a flow diagram of an exemplary process for delivering commercial items in accordance with some embodiments;

FIG. 4 shows a flow diagram of an exemplary process for delivering commercial items in accordance with some embodiments;

FIG. 5 shows a flow diagram of an exemplary process for delivering commercial items in accordance with some embodiments;

FIG. 6 shows a flow diagram of an exemplary process for delivering commercial items in accordance with some embodiments; and

FIG. 7 illustrates an exemplary system for use in implementing methods, techniques, devices, apparatuses, systems, servers, sources and delivering commercial items, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for delivering commercial items. In some embodiments, a first unmanned vehicle (UV) of a plurality of UVs for delivery of commercial items comprises a UV control circuit, a plurality of sensors, and a transport system. In one approach, the UV control circuit may receive a data request for a task elector from a central control circuit via a transceiver. The data request for a task elector may include one or more task identifiers. In one configuration, each of the one or more task identifiers may include a particular set of specification values of a plurality of UV resources adapted to cooperatively operate to complete the corresponding task. In another approach, the UV control circuit may determine, at near-real time, resource values associated with the plurality of UV resources to be cooperatively utilized to fulfill one or more tasks associated with the one or more task identifiers by the first UV. In another approach, the UV control circuit may compare, for each of the one or more task identifiers, each resource value of the resource values to a corresponding specification value of the particular set of specification values. In one configuration, the UV control circuit may assign a particular confidence level to each of the one or more task identifiers based on the comparison. In one example, the particular confidence level may be an estimation that the first UV can fulfill the corresponding task. In another approach, the UV control circuit may provide, for each of the one or more task identifiers, a self-election response indicating an election of the corresponding task to the central control circuit via the transceiver based on the comparison and the assignment of the particular confidence level when each of the resource values is at least within a threshold value the corresponding specification value. In some embodiments, the plurality of sensors may be adapted to provide at the near-real time to the UV control circuit a set of one or more of the resource values of the first UV. In some embodiments, the transport system may include a positioning system. In one approach, the transport system may receive directional data based on one or more elected tasks identifiers of the one or more task identifiers in response to providing the self-election response to the central control circuit. In another approach, the transport system may transport the first UV to a location based on data read from the positioning system and the received directional data.

In some embodiments, a method for self-election of an unmanned vehicle (UV) for delivery of commercial items comprising, wherein the commercial items comprises at least one of retail items or items not-for-resale, receiving a data request for a task elector from a central control circuit via a transceiver. In one approach, the data request for a task elector may include one or more task identifiers. In such an approach, each of the one or more task identifiers may include a particular set of specification values for a plurality of UV resources adapted to cooperatively operate to complete the corresponding task. In another configuration, the method may include determining, at near-real time, resource values associated with the plurality of UV resources to be cooperatively utilized to complete a mission of a first UV of a plurality of UVs. In another configuration, the method may include comparing, for each of the one or more task identifiers, whether each resource value of the resource values is equal to a corresponding specification value of the particular set of specification values. In yet another configuration, the method may include assigning a particular confidence level to each of the one or more task identifiers based on the comparing. In one approach, the particular confidence level may be an estimation that the first UV can complete the corresponding task. In another approach, the method may include providing, for each of the one or more task identifiers, a self-election response indicating an election of the corresponding task to the central control circuit via the transceiver based on the comparing and the assigning of the particular confidence level when each of the resource values is at least equal to the corresponding specification value.

As such, apparatuses, systems, and/or methods described herein provide for a self-electing UV for delivery of commercial items. By one approach, a self-electing UV may assign a particular sub-confidence level to each resource of a plurality of resources associated with a particular task based on specification value corresponding to the resource to fulfill the particular task. Alternatively or in addition to, the self-electing UV may assign a particular confidence level to each task based on resource values of the self-electing UV and the specification values corresponding to resource values associated with the task. Thus, apparatuses, systems, and/or methods associated with delivery of commercial items may provide for a self-election of a UV to one or more task that is believed to simplify and/or improve on automatic and/or efficient delivery of commercial items. In one example, the one or more task may be associated with one or more missions. In such an example, each mission may be associated with one or more retail orders and/or delivery tasks of items not-for-resale.

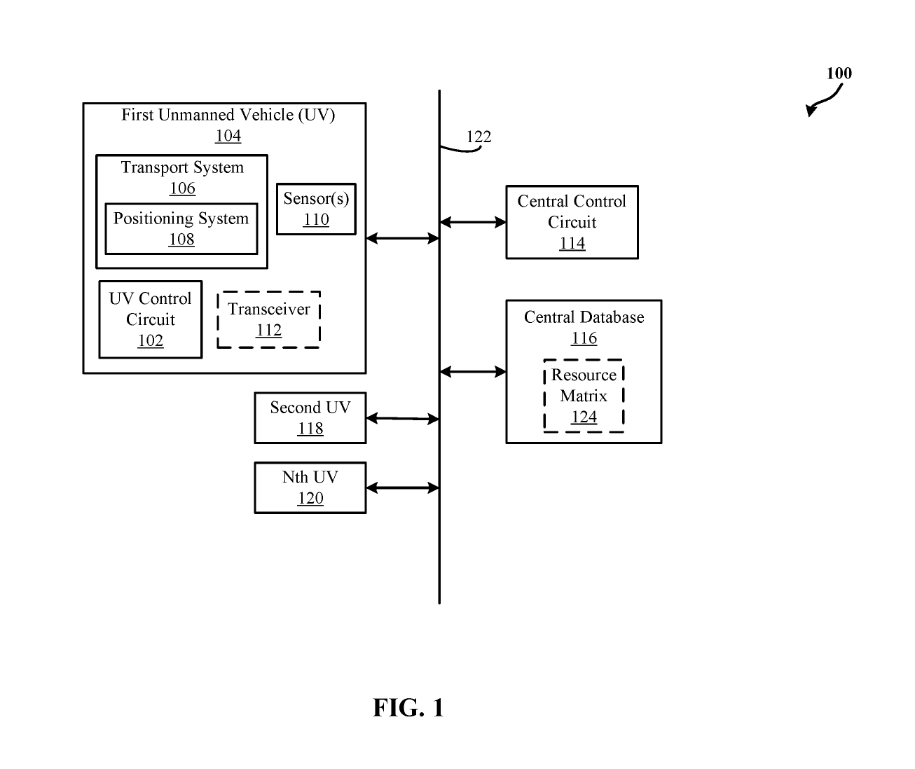

To illustrate, FIGS. 1 through 7 are described below. FIG. 1 illustrates a simplified block diagram of an exemplary system 100 for delivering commercial items, in accordance with some embodiments. The system 100 includes one or more self-electing unmanned vehicles (UVs) 104, 118, 120. By one approach, the system 100 may include a central control circuit 114 communicatively coupled with the one or more self-electing unmanned vehicles (UVs) 104, 118, 120 via one or more communication networks 122. In one configuration, the one or more communication networks 122 may include wired and/or wireless networks using one or more communication protocols and/or standards used for communication between two or more devices adapted to communicate with other devices. For example, the communication protocols and/or standards may include IEEE 802 Standards, and etc. By another approach, the system 100 may include a central database 116 that may be coupled with the one or more UVs 104, 118, 120 and/or the central control circuit 114 via the one or more communication networks 122.

In one configuration, one or more UVs of the one or more UVs 104, 118, 120, for example, the first UV 104, may include a UV control circuit 102. The UV control circuit 102 may receive a data request for a task elector from the central control circuit 114. By one approach, the data request may be received via a transceiver 112. The central control circuit 114 may include one or more servers, computers, mothership UVs, among other type of devices capable of managing, controlling, and/or communicating commands. In one example, the data request for a task elector may include one or more task identifiers. In such an example, each of the one or more task identifiers may include or be used to access a particular set of specification values of a plurality of UV resources adapted to cooperatively operate to complete the corresponding task. By one approach, the plurality of UV resources may include a plurality of sensors and/or capabilities attributable to a UV of the one or more UVs 104, 118, 120. In one configuration, the sensors may include the sensor(s) 110 (the plurality of sensors) adapted to detect and/or respond to some type of input from physical environment(s) and/or electronic components and/or devices. In one example, the input may include light, heat, motion, moisture, pressure, voltage, current, power, digital signal, and/or the like. By one approach, the sensor(s) 110 may include differential global positioning system (D-GPS), global positioning system (GPS), Wi-Fi, wireless integrated network sensors (WINS), thermal camera, light detection and ranging (LIDAR), radio detection and ranging (RADAR), ultra wideband, cell phone connectivity, optical cameras, laser altimeter, and/or the like. Alternatively or in addition to, the capabilities may include facilities on an electronic device, such as a processor, for example, for performing specified tasks and/or functions that a UV of the one or more UVs 104, 118, 120 may have the ability to perform and/or execute. For example, the capabilities may include payload capacity, weather flight potential, wind flight potential, urban flight potential, scouting flight potential, in-air refueling potential, landing pad refueling potential, delivery to a kiosk, port, box, tower, and etc., to name a few.

In another configuration, the UV control circuit 102 may determine, at near-real time, resource values associated with a plurality of UV resources to be cooperatively utilized to fulfill one or more tasks associated with one or more task identifiers received by the first UV 104. By one approach, the one or more tasks may be associated with one or more delivery orders of retail items(s) and/or items not-for-resale. By one approach, the UV control circuit 102 may compare each resource value of the resource values to a corresponding specification value of a particular set of specification values. In one scenario, the comparison may be executed for each of the one or more task identifiers. In a non-limiting illustrative example, a first task assigned to the first UV 104 may correspond to delivering groceries to a house that is 50 miles from a distribution center associated with the first UV 104. As such, the central control circuit 114 may determine based on an access to the central database 116 and a resource matrix 124 stored in the central database 116 that a delivery distance of 50 miles from the distribution center may generally be associated with a battery that is 100% charge. In another scenario, the delivery distance of 50 miles from the distribution center may be associated with a battery that is 70% charge if the central control circuit 114 determines based on the resource matrix 124 that the first task is the only task assigned to the first UV 104. As such, the resource matrix 124 may include a plurality of specification values associated with the plurality of UV resources as described above. By one approach, a plurality of specification values may be associated with a particular UV resource of the plurality of UV resources based on a task assignment. For example, a first task assignment may be associated with a 70% fuel capacity while a second task assignment may be associated with a 30% fuel capacity. Thus, associations of the plurality of specification values associated with the plurality of UV resources may be predetermined at a time an order and/or a request is received from a customer and/or may be based on a standard predetermined association and/or historically determined associations. In response to the central control circuit 114 determining the associations, the central control circuit 114 may update the resource matrix 124 with the determined associations. By one approach, one or more associates and/or agent of a retailer may initiate an update of the resource matrix 124 when specifications or general specifications of the plurality of UVs have changed and/or updated, additional UVs are added in a fleet of UVs associated with the retailer, and/or one or more UVs are removed from the fleet of UVs.

In another configuration, the UV control circuit 102 may assign a particular confidence level to each of the one or more task identifiers based on the comparison. By one approach, the particular confidence level may be an estimation that the first UV 104 can fulfill a corresponding task. In an illustrative non-limiting example, the UV control circuit 102 may have three levels of confidence levels assignable to a task identifier of the one or more task identifiers. A first confidence level may correspond to a UV that exceeds specifications (or resource requirements) for a particular task. A second confidence level may correspond to a UV that is able to meet a set of specifications for the particular task. A third confidence level may correspond to a UV that is unable to meet the set of specifications for the particular task. As such, when the UV control circuit 102 determines resource values associated with the plurality of UV resources associated with the first UV 104, the UV control circuit 102 may perform a self-diagnostic assessment of one or more UV resources of the plurality of UV resources based on the task(s) associated with the data request received from the central control circuit 114. Consequently, based on the resource values determined from the self-diagnostic assessment, the UV control circuit 102 may compare each of the resource values with the particular set of specification values corresponding to UV resources associated with the data request and, in response to the comparison, may assign a particular confidence level to each of the task(s) associated with the data request.

In yet another configuration, the UV control circuit 102 may provide, for at least one of the one or more task identifiers or each of the one or more task identifiers, a self-election response indicating an election of the corresponding task to the central control circuit 114 based on the comparison and the assignment of the particular confidence level when each of the resource values is at least within a threshold value of the corresponding specification value. By one approach, the threshold value of a plurality of threshold values may be included in the data request received by the UV control circuit 102. Alternatively or in addition to, the resource matrix 124 may include the plurality of threshold values used by the plurality of UVs to determine a plurality of confidence levels and/or a plurality of sub-confidence levels. In yet another approach, the plurality of threshold values of the resource matrix 124 may be updated based on a delivery task and/or a mission or a delivery mission. For example, the UV control circuit 102 may assign a second confidence level to a particular task identifier of the one or more task identifiers when each of the resource values is equal to the corresponding specification value or within a range of the corresponding specification value and a threshold value associated with the particular task identifier. In another example, the UV control circuit 102 may assign a third confidence level to the particular task identifier when at least one of the resource values is equal to or greater than the threshold value. In an illustrative non-limiting example, a data request received by the first UV 104 includes a task identifier associated with delivery of an item. Based on the resource matrix 124, the specification values (or requirement) for delivering the item are: payload of 50 pounds (lbs), fuel capacity of 70% based on start of delivery at a particular distribution center to a delivery destination associated with the task identifier, battery charge of 60% when the specified fuel capacity is 70%, night delivery capable, and threshold tolerance of 5.

In one scenario, the UV control circuit 102 may determine the UV resources of the first UV 104 that corresponds to the UV resources associated with the specification values determined from the resource matrix 124 to be the following: payload capacity of 53 pounds (lbs), fuel capacity of 70% based on start of delivery at a particular distribution center to a delivery destination associated with the task identifier, battery charge of 63% when the specified fuel capacity is 70%, and night delivery capable. In response, the UV control circuit 102 may compare each resource value with the corresponding specification value (e.g., the payload value of 53 lbs with the payload specification value of 50 lbs, the fuel capacity of 70% with the fuel capacity specification value of 70%). As such, based on the comparison, if the UV control circuit 102 determines that each resource value is equal to the corresponding specification value or within a range of the corresponding specification value and a threshold value (e.g., the corresponding specification value plus the threshold tolerance of 5), the UV control circuit 102 may assign a zero (0) confidence level to the task. Thus, the first UV 104 may provide a self-election response indicating an election of the task to the central control circuit 114. Alternatively or in addition to, the first UV 104 may purposely de-elect to the task by assigning a confidence level corresponding to not meeting at least one of the specification values if the UV control circuit 102 determines that a total number of elected task associated with the first UV 104 is greater than a predetermined threshold of task efficiency assigned to the first UV 104. In one example, the predetermined threshold of task efficiency may correspond to a total number of tasks that a UV may self-elect itself before the task completion efficiency may be adversely affected when unexpected circumstances happens (e.g., the UV breaks down).

In another scenario, the UV control circuit 102 may determine the UV resources of the first UV 104 to be the following: payload of 70 pounds (lbs), fuel capacity of 90% based on start of delivery at a particular distribution center to a delivery destination associated with the task identifier, battery charge of 100% when the specified fuel capacity is 90%, night delivery capable, and threshold tolerance of 5. As such, based on the comparison of the resource values with the specification values, if the UV control circuit 102 determines that each resource value is equal to or greater than a threshold value (e.g., the corresponding specification value plus the threshold tolerance of 5), the UV control circuit 102 may assign plus one (+1) confidence level to the task. In response, the first UV 104 may provide a self-election response indicating an election of the task to the central control circuit 114.

Alternatively or in addition to, the UV control circuit 102 may provide, for each of the one or more task identifiers for which at least a first resource value of the resource values is less than the corresponding specification value, a non-election response indicating a declination by the first UV 104 of the one or more task identifiers. For example, the non-election response may be provided in response to the UV control circuit 102 assignment of a first confidence level to a particular task when at least one of the resource values associated with the particular task identifier received through the data request is less than the corresponding specification value received through the data request. Continuing the illustrative non-limiting example above, in yet another scenario, the UV control circuit 102 may determine the UV resources of the first UV 104 to be the following: payload of 53 pounds (lbs), fuel capacity of 70% based on start of delivery at a particular distribution center to a delivery destination associated with the task identifier, battery charge of 63% when the specified fuel capacity is 70%, and not capable for night delivery, and threshold tolerance of 5. As such, based on the comparison of the resource values with the specification values (as previously identified above), if the UV control circuit 102 determines that at least one of the resource values is less than the corresponding specification value (e.g., the first UV 104 does not meet the specification of night delivery capable), the UV control circuit 102 may assign minus one (−1) confidence level to the task. In response, the first UV 104 may provide a non-election response indicating a declination by the first UV 104 of the task.

By one approach, the non-election response may include the particular confidence level, a first identifier indicating whether the at least first resource value is associated with a critical resource of the plurality of UV resources or a contingent resource of the plurality of UV resources to the completion of the corresponding task, and a second identifier indicating the at least first resource value. Continuing the illustrative non-limiting example above, the non-election response sent by the UV control circuit 102 may include −1, contingent (if, based on the data request received, the night delivery capability is not a critical value to fulfill the task), and no (or any possible identifier adapted by the first UV 104 to correspond to a negative capability). By one approach, data included in the non-election response and/or the election response may be binary or hexadecimal based.

In another illustrative non-limiting example, the UV control circuit 102 may determine that a resource value for a temperature of a delivery container is 60 degrees Fahrenheit while a corresponding specification value associated with the task identifier is 40 degrees Fahrenheit. Thus, the task identifier indicates that to deliver at least one item of the task, the first UV 104 is expected to maintain the temperature of the delivery container at a temperature of 40 degrees Fahrenheit. Thus, as illustrated in the example, the first UV 104 does not meet the specification requirement to deliver the at least one item. In an example where the temperature of the delivery container is a critical resource value, the UV control circuit 102 may provide a non-election response including −1, critical, and 60. As such, the central control circuit 114 may determine from the received non-election response that the first UV 104 did not meet a critical requirement and that the determined resource value for the critical resource is 60. In this scenario, the central control circuit 114 may perform additional assessment based on the confidence levels received from the plurality of UVs if at least one or more task are left unassigned. Alternatively or in addition to, the election response and/or the non-election response may include a first portion corresponding to a confidence level, a second portion corresponding to one or more identifiers associated with critical or contingency status of the determined resource values that resulted in the assignment of the confidence level, and/or a third portion corresponding to one or more identifiers associated with the determined resource values. In one scenario, the election response and/or the non-election response may include one or more additional portions that may variously aid in communications between the first UV 104, the central control circuit 114, and/or other UVs.

In some embodiment, the UV control circuit 102 may assign a particular sub-confidence level to each resource value of the resource values associated with each of the one or more task identifiers based on the comparison. In an illustrative non-limiting example, the data request received by the first UV 104 may include a first task identifier that are associated with a first specification value for a heated compartment and a second specification value for an ability to navigate through heavy rain. After self-diagnostic assessment of UV resources and comparison of the resulting determined resource values with the first specification value and the second specification value, the UV control circuit 102 may determine that the first UV 104 is not equipped to navigate through heavy rain but is capable of heating the delivery compartment. As such, the UV control circuit 102 may assign a first sub-confidence level to a first resource value corresponding to the first specification value and a second sub-confidence level to a second resource value corresponding to the second specification value. By one approach, the first sub-confidence level may correspond to a sub-confidence level that is equal to a corresponding specification value or within a range of the corresponding specification value and a threshold value associated with the particular task identifier, while the second sub-confidence level indicates that the resource value corresponding to the specification value is less than the corresponding specification value. For example, the UV control circuit 102 may assign a zero (0) sub-confidence level to the heated delivery compartment capability and a minus one (−1) sub-confidence level to the heavy rain navigation capability. As such, in one configuration, the assigned sub-confidence level may correspond to an estimation of a likelihood that the resource value can fulfill the corresponding specification value. By another approach, U.S. Provisional Application No. 62/512,852, filed May 31, 2017, which is incorporated herein by reference in its entirety, may alternatively and/or additionally illustrate and/or describe determination of one or more sub-confidence levels (or confidence values).

In some embodiments, the central control circuit 114 may assign a task to a UV based at least on an evaluation of the sub-confidence levels received from the plurality of UVs. For example, the central control circuit 114 may assign the task to the first UV 104 based on an evaluation of the central control circuit 114 that the first UV 104 may have the highest average value of sub-confidence levels. In another example, the central control circuit 114 may assign the task to the first UV 104 based on the first UV 104 having the highest occurrence of a particular sub-confidence level. By another approach, the central control circuit 114 may evaluate the sub-confidence levels received and determine which UV to assign the task based on the highest summed value of the sub-confidence levels received from each UV. By another approach, the central control circuit 114 may evaluate the sub-confidence levels received and determine which UV to assign the task based on predetermined preferences of sub-confidence level associated with a particular resource value. For example, if the first UV 104 has a +1 sub-confidence level for fuel capacity and the second UV 118 has a 0 sub-confidence level for fuel capacity, based on the predetermined preference for +1 sub-confidence level for fuel capacity, the central control circuit 114 may assign the task to the first UV 104.

Alternatively or in addition to, the determination of which UV of the plurality of UVs to assign a particular task may be based, at least in part, on a total number of task identifiers to be assigned by the central control circuit 114. By one approach, the central control circuit 114 may priority assign a task identifier to the first UV 104 based on the first UV's 104 assigned confidence level assignment and the total number of task identifiers to be assigned being greater than a threshold. For example, both the first UV 104 and the second UV 118 self-elected to a particular task with a zero (0) confidence value and a plus one (+1) confidence value, respectively. Consequently in this example, the total number of task identifiers to be assigned is 100 when the threshold is 20 (e.g., the threshold is a predetermined value to compare with to determine that there are enough self-elected UVs to assign to a plurality of task requiring assignments). In this example, the central control circuit 114 may first assign tasks to those UVs having zero (0) confidence values provided that the total number of task identifiers to be assigned is greater than the threshold. In another example, if the total number of task identifiers to be assigned is less than or equal to the threshold, the central control circuit 114 may randomly assign tasks to those self-elected UVs. As such, in the example described above, since the total number of task identifiers to be assigned is 100 and the threshold is 20, the central control circuit 114 may priority assign the task to the first UV 104 instead of the second UV 118. By one approach, the central control circuit 114 may provide additional data associated with information related to the elected task to the first UV 104.

In some embodiments, the central control circuit 114 may broadcast the data request for a task elector based on the resource matrix 124 stored in the central database 116. Alternatively or in addition to, prior to broadcasting the data request, the central control circuit 114 may predetermine a particular set of UVs to broadcast the data request based on the specification values associated with the tasks and/or the task identifiers. By one approach, the central control circuit 114 may determine task identifiers to associate with a plurality of tasks, the one or more task identifiers to assign, and/or specification values corresponding to a plurality of UV resources based, at least, on an access to the resource matrix 124 by the central control circuit 114. In such an approach, the central control circuit 114 may determine that the one or more task identifiers lack association in the resource matrix 124 with at least one UV of the plurality of UVs. In response, the central control circuit 114 may broadcast the data request for a task elector to the plurality of UVs. In one configuration, the central control circuit 114 may receive a plurality of self-election responses from one or more of the plurality of UVs. By one approach, each of the plurality of self-election responses may include the particular confidence level, a first identifier indicating a do-not-care value, and a second identifier indicating at least one particular resource value of the resource values when the particular confidence level corresponds to a first confidence level. In such an approach, the at least one particular resource value may correspond to the at least one of the resource values that is at least a threshold greater than the corresponding specification value. In yet such an approach, the do-not-care value may be a value not used by the UV control circuit 102. In response, the central control circuit 114 may determine which one of the one or more of the plurality of UVs to assign a particular task of the one or more task identifiers based on the particular confidence level, the second identifier, and/or the assigned priority as described above. In one configuration, the resource matrix may include a plurality of identifiers associated with the plurality of UVs, the plurality of UV resources, the one or more task identifiers, and specification values for each of the plurality of UV resources based on each of the one or more task identifiers. In such a configuration, the one or more task identifiers are at least updated or associated with a plurality of retail orders.

In yet some embodiments, in response to the central control circuit's 114 assignment of one or more elected task identifiers to the first UV 104 based on the self-election response receive from the first UV 104, the central control circuit 114 may provide directional data as a confirmation of the assignment of the one or more elected task identifiers to the first UV 104. By one approach, the central control circuit 114 may receive a de-election request from the first UV 104 when the UV control circuit 102 determines during a self-assessment that the particular confidence level corresponds to a second confidence level when at least one of the resource values is less than the corresponding specification value. In one configuration, the central control circuit 114 may update the central database 116 in response to the de-election request from the first UV 104 by de-associating the first UV 104 from one or more elected task identifiers in the resource matrix 124. In such an approach, the central control circuit 114 may broadcast a second data request for a task elector in response to the de-association of the first UV 104 from the one or more elected task identifiers. In broadcasting the second data request, the central control circuit 114 may solicit self-election of one or more UVs to the one or more elected task identifiers de-elected by the first UV 104.

In some embodiments, the plurality of sensors 110 may be adapted to provide at a near-real time to the UV control circuit 102 a set of one or more of resource values of the first UV 104. By one approach, the transport system 106 may include a positioning system 108. By one approach, the positioning system 108 may include Global Positioning System (GPS), Global Navigation Satellite System (GLONASS), Galileo, and/or the like. In one configuration, the transport system 106 may receive the directional data based on one or more elected tasks identifiers in response to providing the self-election response to the central control circuit 114. As such, the transport system 106 may transport the first UV 104 to a location based on data read from the positioning system 108 and the received directional data.

In some embodiments, the UV control circuit 102 may determine and/or evaluate whether one or more characteristics of one or more streets (e.g., street characteristics may be stored by the central database 116) may render the first UV 104 unable to elect itself to one or more tasks despite an estimation by the UV control circuit 102 that the first UV 104 can fulfill the one or more tasks based on the particular confidence level and the comparison of the resource values with the specification values. For example, a width of at least one of the one or more streets in a delivery route to be taken by the first UV 104 may be too narrow for the first UV 104 to pass through. In another example, the at least one of the one or more streets may be made of cobblestones and the wheels of the first UV 104 are not made of materials that could withstand the stresses brought on by the cobblestones lining the street. Alternatively or in addition to, the UV control circuit 102 and/or the central control circuit 114 may determine and/or evaluate whether traffic flows along the at least one of the one or more streets may impose limitations on which one of the plurality of UVs may elect itself to a task. For example, when a task may be associated with one or more self-electing UVs 104, 118, 120 formed in a chain, the UV control circuit 102 may determine whether a current traffic flow of the at least one of the one or more streets may accommodate a chained plurality of UVs 104, 118, 120. Alternatively or in addition to, the UV control circuit 102 may determine and/or evaluate whether environmental and/or regulatory requirements, codes, and/or ordinances are associated with the at least one of the one or more streets via an access to the central database 116. By one approach, the UV control circuit 102 may compare one or more regulatory requirements, codes, and/or ordinances with relevant information that are associated with at least one of the first UV 104 and the plurality of retail orders. For example, one or more regulatory requirements, codes, and/or ordinances may include direction of flow of traffic, day of the week, stopping/parking on the side of the streets, time of day, signage, colors, lighting, distance between objects, tailgating, building, speed, type of cargo carried by a UV, events taking place during the delivery, anticipated traffic levels, and/or UV energy efficiency requirements. In one scenario, the UV control circuit 102 may direct the transport system 106 to reroute and/or transport the first UV 104 through other street if a local ordinance prohibits UVs 104, 118, 120 from going through the other street based on a particular time of day and/or events taking place on the other street. Alternatively or in addition to, the central control circuit 114 may be triggered by the rerouting to send a subsequent data request for a task elector to continue a delivery started but unable to be completed by the first UV 104. In an example, each of the UVs 104, 118, 120 and/or the central control circuit 114 may determine one or more characteristics of one or more streets associated with one or more delivery paths/routes and/or regulatory requirements, codes, and/or ordinances affecting the ability of one or more of the UVs 104, 118, 120 to self-elect itself. By one approach, one or more task identifiers may be associated with one or more streets that the one or more of the UVs 104, 118, 120 may go through to make a delivery. As such, depending on one or more limitations imposed by the characteristics of the streets that a UV may traverse through to make the delivery, a particular UV 104, 118, 120 may be eliminated from a pool of candidate UVs 104, 118, 120 that may self-elect to a task. In one configuration, the central database 116 may store a plurality of combinations of streets associated with each of the one or more task identifiers. In another configuration, the central control circuit 114 may determine the plurality of combinations of streets to associate with each of the one or more task identifiers based on a corresponding retail order of a plurality of retail orders associated with each of the one or more task identifiers. For example, each of the plurality of retail orders may be associated with a location and/or a delivery location. As such, the central control circuit 114 may determine a delivery path that a UV may take to get to the location and/or the delivery location. By one approach, the delivery path may include one or more streets.

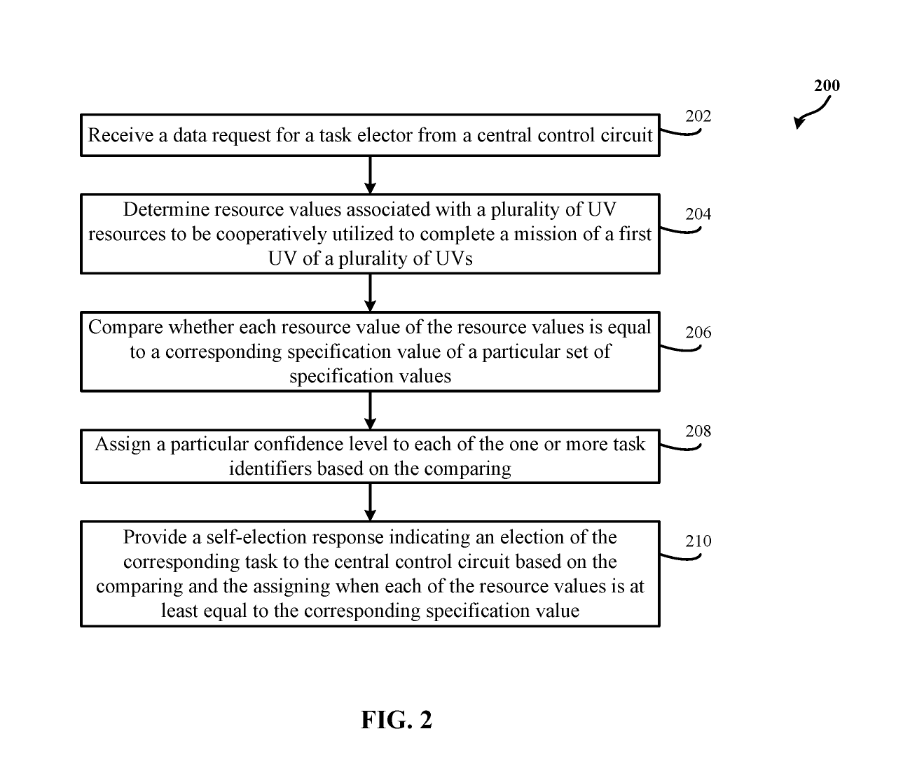

FIG. 2 illustrates a flow diagram of an exemplary method 200 for delivering commercial items using a self-electing UV, in accordance with some embodiments. The exemplary method 200 may be implemented in the system 100 of FIG. 1. By one approach, the method 200 and/or one or more steps of the method may be implemented in at least one of the first UV 104, the second UV 118, the Nth UV 120, the UV control circuit 102, or the central control circuit 114 of FIG. 1. The method 200 includes, at step 202, receiving a data request for a task elector from a central control circuit via a transceiver. By one approach, the data request for a task elector may include one or more task identifiers. In such an approach, each of the one or more task identifiers may include a particular set of specification values for a plurality of UV resources adapted to cooperatively operate to complete the corresponding task. In one configuration, the method 200 may include, at step 204, determining, at near-real time, resource values associated with the plurality of UV resources to be cooperatively utilized to complete a mission of a first UV of a plurality of UVs. The method 200 may also include comparing whether each resource value of the resource values is equal to a corresponding specification value of the particular set of specification values, at step 206. By one approach, the comparison may be performed for each of one or more task identifiers. In another configuration, the method 200 may include, at step 208, assigning a particular confidence level to each of the one or more task identifiers based on the comparing. By one approach, the particular confidence level may be an estimation that the first UV can complete the corresponding task. In yet another configuration, the method 200 may include providing a self-election response indicating an election of the corresponding task to the central control circuit via the transceiver based on the comparing and the assigning of the particular confidence level when each of the resource values is at least equal to the corresponding specification value, at step 210. By one approach, the self-election response may be provided for each of the one or more task identifiers based on the comparing and the assigning of the particular confidence level.

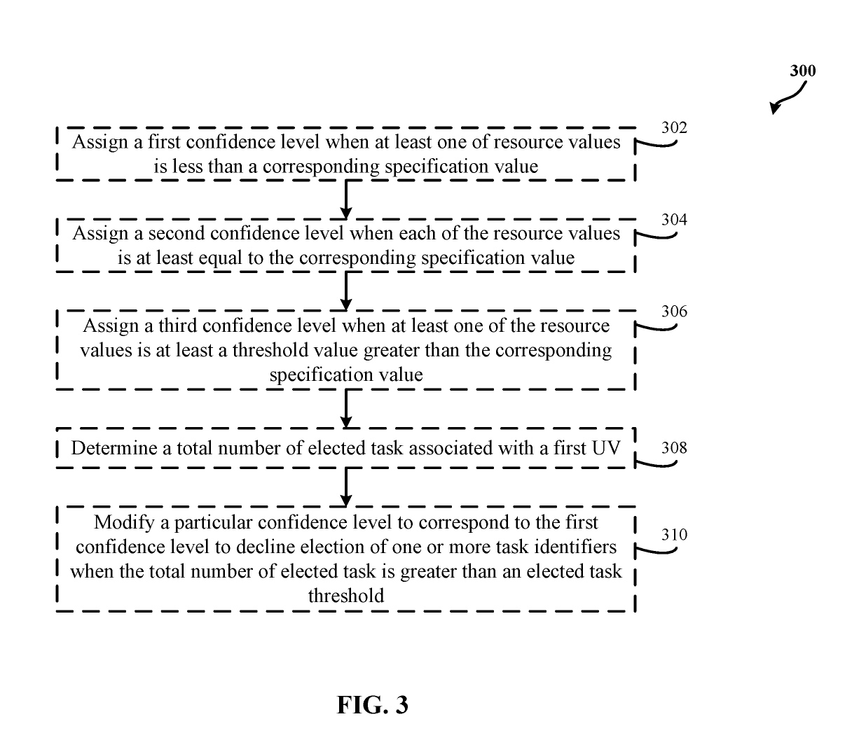

FIG. 3 illustrates a flow diagram of an exemplary method 300 for delivering commercial items using a self-electing UV, in accordance with some embodiments. The exemplary method 300 may be implemented in the system 100 of FIG. 1. By one approach, the method 300 and/or one or more steps of the method may be implemented in at least one of the first UV 104, the second UV 118, the Nth UV 120, the UV control circuit 102, or the central control circuit 114 of FIG. 1. By another approach, the method 300 and/or one or more steps of the method may optionally be included in and/or performed in cooperation with the method 200 of FIG. 2. The method 300 includes, at step 302, assigning a first confidence level when at least one of resource values is less than a corresponding specification value. By one approach, the method 300 may include, at step 304, assigning a second confidence level when each of the resource values is at least equal to the corresponding specification value. By another approach, the method 300 may include, at step 306, assigning a third confidence level when at least one of the resource values is at least a threshold value greater than the corresponding specification value. In one configuration, the assignment in at least one of the steps 302, 304, and 306 may be performed for each of one or more task identifiers. By another approach, the method 300 may include, at step 308, determining a total number of elected task associated with the first UV. By yet another approach, the method 300 may include modifying a particular confidence level to correspond to the first confidence level to decline election of the one or more task identifiers when the total number of elected task is greater than an elected task threshold, at step 310.

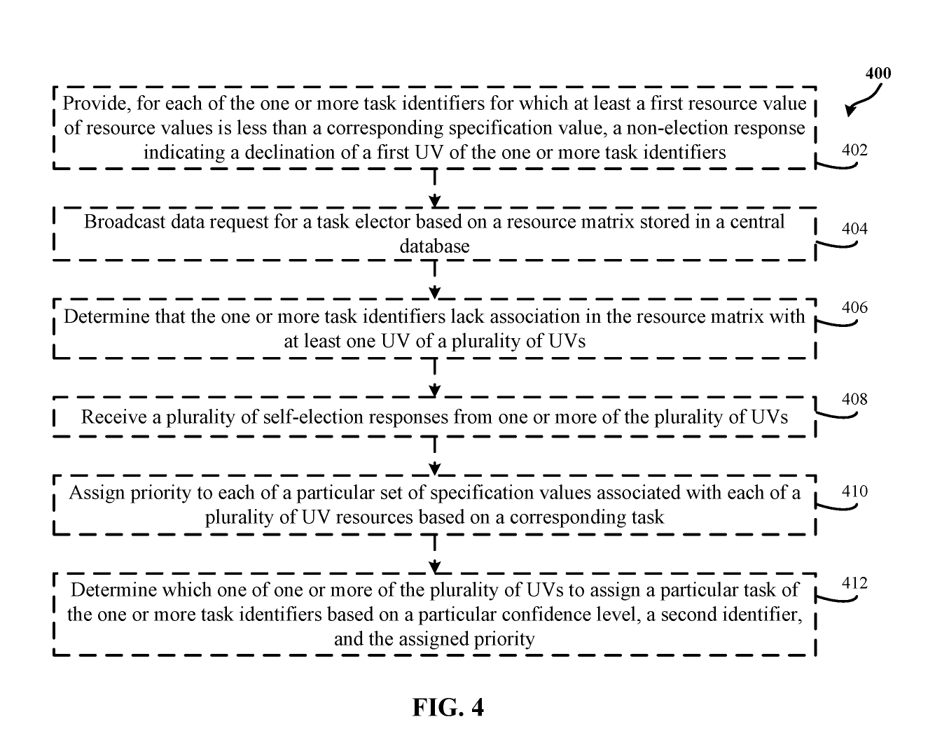

FIG. 4 illustrates a flow diagram of an exemplary method 400 for delivering commercial items using a self-electing UV, in accordance with some embodiments. The exemplary method 400 may be implemented in the system 100 of FIG. 1. By one approach, the method 400 and/or one or more steps of the method may be implemented in at least one of the first UV 104, the second UV 118, the Nth UV 120, the UV control circuit 102, or the central control circuit 114 of FIG. 1. By another approach, the method 400 and/or one or more steps of the method may optionally be included in and/or performed in cooperation with the method 200 of FIG. 2 and/or the method 300 of FIG. 3. The method 400 includes, at step 402, providing, for each of one or more task identifiers for which at least a first resource value of resource values is less than a corresponding specification value, a non-election response indicating a declination of the first UV of the one or more task identifiers. In one configuration, the non-election response may include a particular confidence level, a first identifier indicating whether at least a first resource value is a critical resource of a plurality of UV resources or a contingent resource of the plurality of UV resources to the completion of the corresponding task, and a second identifier indicating the at least first resource value. By one approach, the method 400 may include, at step 404, broadcasting data request for a task elector based on a resource matrix stored in a central database, wherein the central database is configured to store the resource matrix including a plurality of identifiers associated with a plurality of UVs, a plurality of UV resources, one or more task identifiers, and specification values for each of the plurality of UV resources based on each of the one or more task identifiers. In one configuration, the one or more task identifiers may be at least updated or associated with a plurality of retail orders. By another approach, the method 400 may include determining that the one or more task identifiers may lack association in the resource matrix with at least one UV of the plurality of UVs, at step 406.

In some embodiments, the method 400 may include, at step 408, receiving a plurality of self-election responses from one or more of a plurality of UVs. In one example, each of a plurality of self-election responses may include a particular confidence level, a first identifier indicating a do-not-care value, and a second identifier indicating at least one particular resource value of resource values when the particular confidence level corresponds to a first confidence level. In such an example, at least one particular resource value may correspond to at least one of the resource values that is at least a threshold greater than a corresponding specification value. In another example, the do-not-care value may be a value not used by a UV control circuit. In yet another example, a central control circuit may receive the plurality of self-election responses. In one configuration, the method 400 may include, at step 410, assigning priority to each of a particular set of specification values associated with each of a plurality of UV resources based on a corresponding task. In another configuration, the method 400 may include determining which one of one or more of the plurality of UVs to assign a particular task of one or more task identifiers based on the particular confidence level, the second identifier, and the assigned priority, at step 412. By one approach, a central control circuit may determine the one of one or more of the plurality of UVs to assign the particular task.

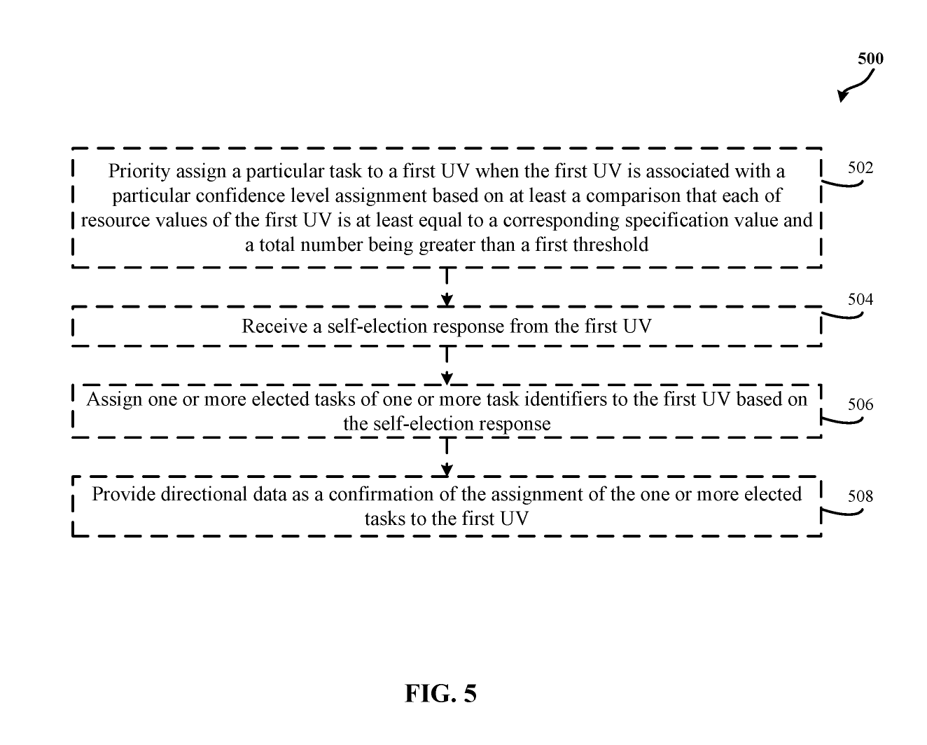

FIG. 5 illustrates a flow diagram of an exemplary method 500 for delivering commercial items using a self-electing UV, in accordance with some embodiments. The exemplary method 500 may be implemented in the system 100 of FIG. 1. By one approach, the method 500 and/or one or more steps of the method may be implemented in at least one of the first UV 104, the second UV 118, the Nth UV 120, the UV control circuit 102, or the central control circuit 114 of FIG. 1. By another approach, the method 500 and/or one or more steps of the method may optionally be included in and/or performed in cooperation with the method 200 of FIG. 2, the method 300 of FIG. 3, and/or the method 400 of FIG. 4. The method 500 includes, at step 502, priority assigning a particular task to a first UV when the first UV is associated with a particular confidence level assignment based on at least a comparison that each of resource values of the first UV is at least equal to a corresponding specification value and a total number of one or more task identifiers being greater than a first threshold. By one approach, determining one of one or more of a plurality of UVs to assign the particular task may be based at least on the total number of the one or more task identifiers. By one approach, the method 500 may include, at step 504, receiving a self-election response from the first UV. In one example, a central control circuit may receive the self-election response. By another approach, the method 500 may include, at step 506, assigning one or more elected tasks of the one or more task identifiers to the first UV based on the self-election response. In one example, the central control circuit may further assign the one or more elected tasks. By another approach, the method 500 may include providing directional data as a confirmation of the assignment of the one or more elected tasks to the first UV, at step 508. In yet another example, the central control circuit may provide the directional data.

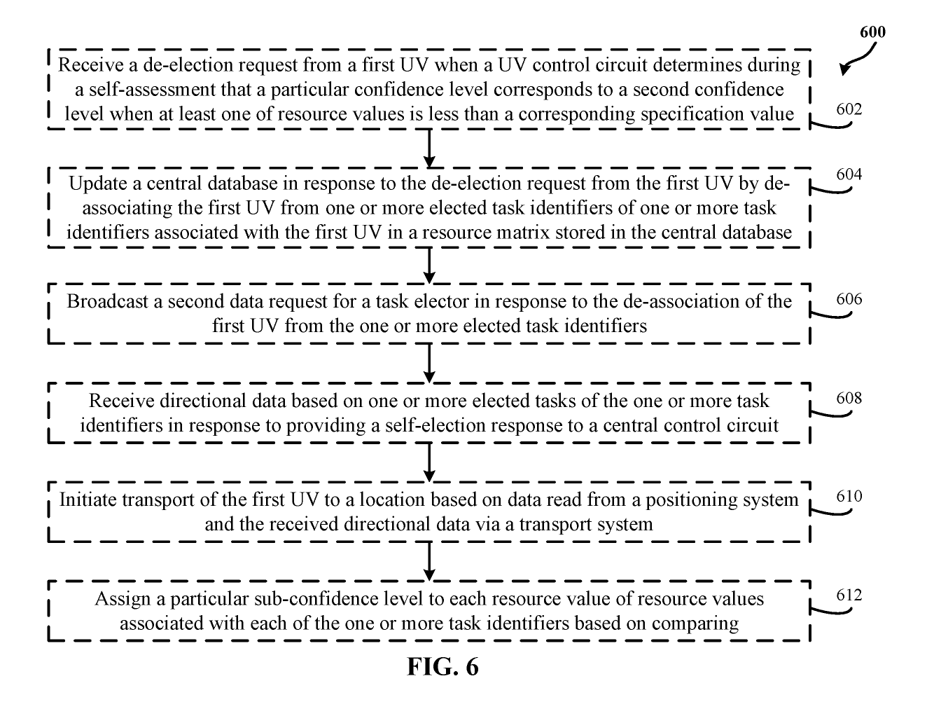

FIG. 6 illustrates a flow diagram of an exemplary method 600 for delivering commercial items using a self-electing UV, in accordance with some embodiments. The exemplary method 600 may be implemented in the system 100 of FIG. 1. By one approach, the method 600 and/or one or more steps of the method may be implemented in at least one of the first UV 104, the second UV 118, the Nth UV 120, the UV control circuit 102, or the central control circuit 114 of FIG. 1. By another approach, the method 600 and/or one or more steps of the method may optionally be included in and/or performed in cooperation with the method 200 of FIG. 2, the method 300 of FIG. 3, the method 400 of FIG. 4, and/or the method 500 of FIG. 5. The method 600 includes, at step 602, receiving a de-election request from a first UV when a UV control circuit determines during a self-assessment that a particular confidence level corresponds to a second confidence level when at least one of resource values is less than a corresponding specification value. By one approach, the method 600 may include, at step 604, updating a central database in response to the de-election request from the first UV by de-associating the first UV from one or more elected task identifiers of one or more task identifiers associated with the first UV in a resource matrix stored in a central database. In one configuration, the resource matrix may include a plurality of identifiers associated with a plurality of UVs, a plurality of UV resources, the one or more task identifiers, and specification values for each of the plurality of UV resources based on each of the one or more task identifiers. In such a configuration, the one or more task identifiers are associated with a plurality of retail orders. By one approach, the method 600 may include broadcasting a second data request for a task elector in response to the de-association of the first UV from the one or more elected task identifiers, at step 606. In one example, one or more of the steps 602, 604, and 606 may be performed by a central control circuit.

In some embodiments, the method 600 may include receiving directional data based on one or more elected tasks of the one or more task identifiers in response to providing the self-election response to the central control circuit, at step 608. By one approach, the method 600 may include, at step 610, initiating transport of the first UV to a location based on data read from a positioning system and the received directional data via a transport system. By another approach, the method 600 may include, at step 612, assigning a particular sub-confidence level to each resource value of resource values associated with each of the one or more task identifiers based on a comparison. In one example, the comparison may be on whether each resource value of the resource values may be equal to a corresponding specification value of a particular set of specification values. In another example, the particular sub-confidence level may be an estimation of likelihood that corresponding resource value of the resource values fulfills the corresponding specification value. In such an example, an assignment of a task of the one or more tasks by a central control circuit may be based at least on the particular sub-confidence level when one or more UVs of the plurality of UVs have the same assignment of the particular confidence level associated with a task.

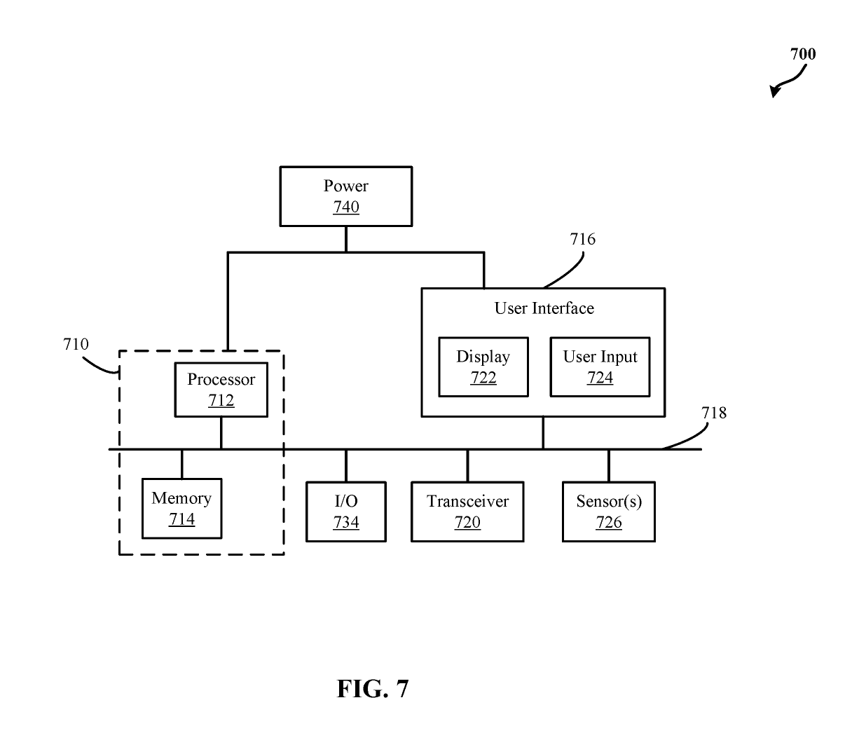

Further, the circuits, circuitry, systems, devices, processes, methods, techniques, functionality, services, servers, sources and the like described herein may be utilized, implemented and/or run on many different types of devices and/or systems. FIG. 7 illustrates an exemplary system 700 that may be used for implementing any of the components, circuits, circuitry, systems, functionality, apparatuses, processes, or devices of the system 100 of FIG. 1, the method 200 of FIG. 2, the method 300 of FIG. 3, the method 400 of FIG. 4, the method 500 of FIG. 5, the method 600 of FIG. 6, and/or other above or below mentioned systems or devices, or parts of such circuits, circuitry, functionality, systems, apparatuses, processes, or devices. For example, the system 700 may be used to implement some or all of the system for delivering commercial items using the UVs 104, 118, 120, the UV control circuit 102, the transport system 106, the sensor(s) 110, the central control circuit 114, the central database 116, the transceiver 112, the positioning system 108, and/or other such components, circuitry, functionality and/or devices. However, the use of the system 700 or any portion thereof is certainly not required.

By way of example, the system 700 may comprise a processor module (or a control circuit) 712, memory 714, and one or more communication links, paths, buses or the like 718. Some embodiments may include one or more user interfaces 716, and/or one or more internal and/or external power sources or supplies 740. The control circuit 712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 712 can be part of control circuitry and/or a control system 710, which may be implemented through one or more processors with access to one or more memory 714 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 700 may be used to implement one or more of the above or below, or parts of, components, circuits, systems, processes and the like. For example, the system 700 may implement the system 100 for delivery of commercial items with the UV control circuit 102 and/or the central control circuit 114 being the control circuit 712.

The user interface 716 can allow a user to interact with the system 700 and receive information through the system. In some instances, the user interface 716 includes a display 722 and/or one or more user inputs 724, such as buttons, touch screen, track ball, keyboard, mouse, etc., which can be part of or wired or wirelessly coupled with the system 700. Typically, the system 700 further includes one or more communication interfaces, ports, transceivers 720 and the like allowing the system 700 to communicate over a communication bus, a distributed computer and/or communication network (e.g., a local area network (LAN), the Internet, wide area network (WAN), etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include one or more input/output (I/O) interface 734 that allow one or more devices to couple with the system 700. The I/O interface can be substantially any relevant port or combinations of ports, such as but not limited to USB, Ethernet, or other such ports. The I/O interface 734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 726 to provide information to the system and/or sensor information that is communicated to another component, such as the UVs 104, 118, 120, the UV control circuit 102, the transport system 106, the central control circuit 114, the central database 116, the transceiver 112, the positioning system 108, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 700 comprises an example of a control and/or processor-based system with the control circuit 712. Again, the control circuit 712 can be implemented through one or more processors, controllers, central processing units, logic, software and the like. Further, in some implementations the control circuit 712 may provide multiprocessor functionality.

The memory 714, which can be accessed by the control circuit 712, typically includes one or more processor readable and/or computer readable media accessed by at least the control circuit 712, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some or all of the memory 714 can be internal, external or a combination of internal and external memory of the control circuit 712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 714 can store code, software, executables, scripts, data, content, lists, programming, programs, log or history data, user information, customer information, product information, and the like. While FIG. 7 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A self-electing unmanned vehicle (UV) for delivery of commercial items comprising, wherein the commercial items comprises at least one of retail items or items not-for-resale:
a first UV of a plurality of UVs comprising:
a UV control circuit configured to:
receive a data request for a task elector from a central control circuit via a transceiver, wherein the data request for a task elector comprises one or more task identifiers, and wherein each of the one or more task identifiers comprises a particular set of specification values of a plurality of UV resources adapted to cooperatively operate to complete the corresponding task;
determine whether at least one of: a street characteristic, a regulatory requirement, a code, and an ordinance particular to one or more streets associated with the one or more task identifiers renders the first UV unable to make a self-election response;
in response to the determination that the first UV is able to make the self-election response, determine, at near-real time, resource values associated with the plurality of UV resources to be cooperatively utilized to fulfill one or more tasks associated with the one or more task identifiers by the first UV;
compare, for each of the one or more task identifiers, each resource value of the resource values to a corresponding specification value of the particular set of specification values;
assign a particular confidence level to each of the one or more task identifiers based on the comparison, wherein the particular confidence level is an estimation that the first UV can fulfill the corresponding task; and
provide, for each of the one or more task identifiers, the self-election response indicating an election of the corresponding task to the central control circuit via the transceiver based on the comparison and the assignment of the particular confidence level when each of the resource values is at least within a threshold value of the corresponding specification value;
a plurality of sensors adapted to provide at the near-real time to the UV control circuit a set of one or more of the resource values of the first UV; and
a transport system comprising a positioning system, the transport system configured to:
receive directional data based on one or more elected tasks identifiers of the one or more task identifiers in response to providing the self-election response to the central control circuit; and
transport the first UV to a location based on data read from the positioning system and the received directional data.

2. The self-electing UV of claim 1, wherein the UV control circuit is further configured to, in the assignment of the particular confidence level:
assign, for each of the one or more task identifiers, a first confidence level when at least one of the resource values is less than the corresponding specification value;
assign, for each of the one or more task identifiers, a second confidence level when each of the resource values is equal to the corresponding specification value or within a range of the corresponding specification value and a threshold value; and
assign, for each of the one or more task identifiers, a third confidence level when at least one of the resource values is equal to or greater than the threshold value.

3. The self-electing UV of claim 2, wherein the self-election response comprises the particular confidence level, a first identifier indicating a do-not-care value, and a second identifier indicating at least one particular resource value of the resource values when the particular confidence level corresponds to the third confidence level, wherein the at least one particular resource value corresponds to the at least one of the resource values that is at least the threshold value greater than the corresponding specification value, and wherein the do-not-care value is a value not used by the UV control circuit.

4. The self-electing UV of claim 1, wherein the UV control circuit is further configured to provide, for each of the one or more task identifiers for which at least a first resource value of the resource values is less than the corresponding specification value, a non-election response indicating a declination by the first UV of the one or more task identifiers, and wherein the non-election response comprises the particular confidence level, a first identifier indicating whether the at least first resource value is associated with a critical resource of the plurality of UV resources or a contingent resource of the plurality of UV resources to the completion of the corresponding task, and a second identifier indicating the at least first resource value.

5. The self-electing UV of claim 1, further comprising:
the central control circuit coupled to the plurality of UVs, the central control circuit configured to:
broadcast the data request for a task elector based on a resource matrix stored in a central database;
determine that the one or more task identifiers lack association in the resource matrix with at least one UV of the plurality of UVs;
receive a plurality of self-election responses from one or more of the plurality of UVs, wherein each of the plurality of self-election responses comprises the particular confidence level, a first identifier indicating a do-not-care value, and a second identifier indicating at least one particular resource value of the resource values when the particular confidence level corresponds to a first confidence level, wherein the at least one particular resource value corresponds to the at least one of the resource values that is at least a threshold greater than the corresponding specification value, and wherein the do-not-care value is a value not used by the UV control circuit; and
determine which one of the one or more of the plurality of UVs to assign a particular task of the one or more task identifiers based on the particular confidence level and the second identifier; and
the central database coupled to the central control circuit, the central database configured to store the resource matrix comprising a plurality of identifiers associated with the plurality of UVs, the plurality of UV resources, the one or more task identifiers, and specification values for each of the plurality of UV resources based on each of the one or more task identifiers, wherein the one or more task identifiers are at least updated or associated with a plurality of retail orders.

6. The self-electing UV of claim 5, wherein the determination of the one of the one or more of the plurality of UVs to assign the particular task is further based on a total number of the one or more task identifiers, wherein the central control circuit is further configured to priority assign the particular task to the first UV when the first UV is associated with the particular confidence level assignment based on at least the comparison that each of the resource values of the first UV is at least equal to the corresponding specification value and the total number being greater than a first threshold.

7. The self-electing UV of claim 1, wherein the UV control circuit is further configured to assign a particular sub-confidence level to each resource value of the resource values associated with each of the one or more task identifiers based on the comparison, wherein the particular sub-confidence level is an estimation of likelihood that corresponding resource value of the resource values fulfills the corresponding specification value, and wherein an assignment of a task of the one or more tasks by the central control circuit is based at least on the particular sub-confidence level when one or more UVs of the plurality of UVs have the same assignment of the particular confidence level associated with the task.

8. The self-electing UV of claim 1, further comprising the central control circuit configured to:
receive the self-election response from the first UV;
assign one or more elected task identifiers of the one or more task identifiers to the first UV based on the self-election response; and
provide the directional data as a confirmation of the assignment of the one or more elected task identifiers to the first UV.

9. The self-electing UV of claim 8, wherein the central control circuit is further configured to:
receive a de-election request from the first UV when the UV control circuit determines during a self-assessment that the particular confidence level corresponds to a second confidence level when at least one of the resource values is less than the corresponding specification value;
update a central database in response to the de-election request from the first UV by de-associating the first UV from one or more elected task identifiers of the one or more task identifiers associated with the first UV in a resource matrix stored in the central database, wherein the resource matrix comprises a plurality of identifiers associated with the plurality of UVs, the plurality of UV resources, the one or more task identifiers, and specification values for each of the plurality of UV resources based on each of the one or more task identifiers, and wherein the one or more task identifiers are associated with a plurality of retail orders; and
broadcast a second data request for a task elector in response to the de-association of the first UV from the one or more elected task identifiers.

10. A method for self-election of an unmanned vehicle (UV) for delivery of commercial items comprising, wherein the commercial items comprises at least one of retail items or items not-for-resale:
receiving a data request for a task elector from a central control circuit via a transceiver, wherein the data request for a task elector comprises one or more task identifiers, and wherein each of the one or more task identifiers comprises a particular set of specification values for a plurality of UV resources adapted to cooperatively operate to complete the corresponding task;
determining whether at least one of: a street characteristic, a regulatory requirement, a code, and an ordinance particular to one or more streets associated with the one or more task identifiers renders the first UV unable to make a self-election response;
in response to the determining that the first UV is able to make the self-election response, determining, at near-real time, resource values associated with the plurality of UV resources to be cooperatively utilized to complete a mission of a first UV of a plurality of UVs;
comparing, for each of the one or more task identifiers, whether each resource value of the resource values is equal to a corresponding specification value of the particular set of specification values;
assigning a particular confidence level to each of the one or more task identifiers based on the comparing, wherein the particular confidence level is an estimation that the first UV can complete the corresponding task; and
providing, for each of the one or more task identifiers, the self-election response indicating an election of the corresponding task to the central control circuit via the transceiver based on the comparing and the assigning of the particular confidence level when each of the resource values is at least equal to the corresponding specification value.

11. The method of claim 10, wherein the assigning of the particular confidence level further comprises:
assigning, for each of the one or more task identifiers, a first confidence level when at least one of the resource values is less than the corresponding specification value;
assigning, for each of the one or more task identifiers, a second confidence level when each of the resource values is at least equal to the corresponding specification value; and
assigning, for each of the one or more task identifiers, a third confidence level when at least one of the resource values is at least a threshold value greater than the corresponding specification value.

12. The method of claim 11, wherein the self-election response comprises the particular confidence level, a first identifier indicating a do-not-care value, and a second identifier indicating at least one particular resource value of the resource values when the particular confidence level corresponds to the third confidence level, wherein the at least one particular resource value corresponds to the at least one of the resource values that is at least the threshold value greater than the corresponding specification value, and wherein the do-not-care value is a value not used by the UV control circuit, and further comprising:
determining a total number of elected task associated with the first UV; and
modifying the particular confidence level to correspond to the first confidence level to decline election of the one or more task identifiers when the total number of elected task is greater than an elected task threshold.

13. The method of claim 10, further comprising: providing, for each of the one or more task identifiers for which at least a first resource value of the resource values is less than the corresponding specification value, a non-election response indicating a declination of the first UV of the one or more task identifiers, wherein the non-election response comprises the particular confidence level, a first identifier indicating whether the at least first resource value is a critical resource of the plurality of UV resources or a contingent resource of the plurality of UV resources to the completion of the corresponding task, and a second identifier indicating the at least first resource value.

14. The method of claim 10, further comprising:
broadcasting the data request for a task elector based on a resource matrix stored in a central database, wherein the central database is configured to store the resource matrix comprising a plurality of identifiers associated with the plurality of UVs, the plurality of UV resources, the one or more task identifiers, and specification values for each of the plurality of UV resources based on each of the one or more task identifiers, wherein the one or more task identifiers are at least updated or associated with a plurality of retail orders; and
determining that the one or more task identifiers lack association in the resource matrix with at least one UV of the plurality of UVs.

15. The method of claim 14, further comprising:
receiving, by the central control circuit, a plurality of self-election responses from one or more of the plurality of UVs, wherein each of the plurality of self-election responses comprises the particular confidence level, a first identifier indicating a do-not-care value, and a second identifier indicating at least one particular resource value of the resource values when the particular confidence level corresponds to a first confidence level, wherein the at least one particular resource value corresponds to the at least one of the resource values that is at least a threshold greater than the corresponding specification value, and wherein the do-not-care value is a value not used by the UV control circuit;
assigning priority to each of the particular set of specification values associated with each of the plurality of UV resources based on the corresponding task; and
determining, by the central control circuit, which one of the one or more of the plurality of UVs to assign a particular task of the one or more task identifiers based on the particular confidence level, the second identifier, and the assigned priority.

16. The method of claim 15, wherein the determining of the one of the one or more of the plurality of UVs to assign the particular task is further based on a total number of the one or more task identifiers, and further comprising priority assigning the particular task to the first UV when the first UV is associated with the particular confidence level assignment based on at least the comparison that each of the resource values of the first UV is at least equal to the corresponding specification value and the total number being greater than a first threshold.

17. The method of claim 10, further comprising:
receiving, by the central control circuit, the self-election response from the first UV;
assigning, by the central control circuit, one or more elected tasks of the one or more task identifiers to the first UV based on the self-election response; and
providing, by the central control circuit, directional data as a confirmation of the assignment of the one or more elected tasks to the first UV.

18. The method of claim 17, further comprising:
receiving, by the central control circuit, a de-election request from the first UV when the UV control circuit determines during a self-assessment that the particular confidence level corresponds to a second confidence level when at least one of the resource values is less than the corresponding specification value;
updating, by the central control circuit, a central database in response to the de-election request from the first UV by de-associating the first UV from one or more elected task identifiers of the one or more task identifiers associated with the first UV in a resource matrix stored in the central database, wherein the resource matrix comprises a plurality of identifiers associated with the plurality of UVs, the plurality of UV resources, the one or more task identifiers, and specification values for each of the plurality of UV resources based on each of the one or more task identifiers, and wherein the one or more task identifiers are associated with a plurality of retail orders; and
broadcasting, by the central control circuit, a second data request for a task elector in response to the de-association of the first UV from the one or more elected task identifiers.

19. The method of claim 10, further comprising:
receiving directional data based on one or more elected tasks of the one or more task identifiers in response to providing the self-election response to the central control circuit; and
initiating transport of the first UV to a location based on data read from a positioning system and the received directional data via a transport system.

20. The method of claim 10, further comprising assigning a particular sub-confidence level to each resource value of the resource values associated with each of the one or more task identifiers based on the comparing, wherein the particular sub-confidence level is an estimation of likelihood that corresponding resource value of the resource values fulfills the corresponding specification value, and wherein an assignment of a task of one or more tasks by the central control circuit is based at least on the particular sub-confidence level when one or more UVs of the plurality of UVs have the same assignment of the particular confidence level associated with the task.
